(19) United States
(12) Patent Application Publication
(10) Pub. No.: US 2015/0072229 A1
(43) Pub. Date: Mar. 12, 2015

(54) ALKALINE BATTERY COMPRISING A POLYOLEFIN GAS CHANNELING SEPARATOR INLAY

(71) Applicant: Encell Technology, Inc., Alachua, FL (US)

(72) Inventor: Randy Gene OGG, Newberry, FL (US)

(73) Assignee: ENCELL TECHNOLOGY, INC., Alachua, FL (US)

(21) Appl. No.: 14/482,249

(22) Filed: Sep. 10, 2014

Related U.S. Application Data
(60) Provisional application No. 61/876,021, filed on Sep. 10, 2013.
(60) Provisional application No. 61/907,533, filed on Nov. 22, 2013.

(51) Int. Cl. H01M 2/16; H01M 2/18

(52) U.S. Cl. CPC H01M 2/162; H01M 2/18; H01M 10/26
USPC 429/206; 429/246

(57) ABSTRACT

Provided is an alkaline battery comprising a positive electrode, a negative electrode, electrolyte, and a polyolefin separator/inlay interposed between the positive and negative electrodes, with the polyolefin separator/inlay having channels that allow for movement of gas. In one embodiment, the polyolefin separator inlay has channels that exist in two planes.

### CROSS REFERENCE TO RELATED APPLICATIONS

The present application claims priority to provisional applications U.S. 61/876,021 filed on Sep. 10, 2013 and U.S. 61/907,533 filed on Nov. 22, 2013, with both applications herein incorporated by reference in their entirety.

### BACKGROUND OF THE INVENTION

1. Field of Invention

The present invention is in the technical field of energy storage devices. More particularly, the present invention is in the technical field of rechargeable batteries using an alkaline electrolyte.

2. State of the Art

Batteries with an alkaline electrolyte have been known for over a hundred years. Most of these batteries are based on the use of a nickel oxide active material as the cathode paired with a various metals or metal-hydrides as the anode. A number of types of cell construction are possible for each of these batteries. These variations in cell construction lie mostly in the nature of electrode support utilized. For the positive electrode three principal types are recognized—pocket plate, sintered plate and foam-based plates. An electrode support is necessary because the active material (nickel hydroxide) is a solid and held in pockets in the pocket-plate-design, held in the pores of the sintered plate design, or mixed with gel or paste and placed in foam-based plate electrodes. Also, cobalt, cobalt hydroxide, zinc hydroxide, cadmium hydroxide, yttrium hydroxide, and/or other metal hydroxides need to be added to improve the conductivity of nickel hydroxide.

Negative electrode designs make use of an even broader range of materials including pocket plates, sintered nickel powder, fiber, foam and plastic bonded supports. It is the physical stability of the active material in the negative electrode that permits such a wide variety of support materials. Nickel hydroxide in the positive electrode, however, swells appreciably during charge and discharge, straining the support and restricting the choice of support type at the positive electrode. In all cell construction types, a separator is placed between the two electrodes to prevent short circuits.

The separator used in the cell construction depends upon the types of electrodes used. In cells with a pocket plate electrodes, the anode and cathode are kept electrically isolated using a spacer or a grid-like mesh inlay, and are typically held in a rigid frame. The open space between the electrodes allows for hydrogen and oxygen gas to diffuse away from the electrode and out of the electrolyte where it will not interfere with ionic transport and the electrochemical reactions at the electrode-electrolyte interface. However, the construction of these cells is more expensive as the electrode design is not amenable to lower-cost manufacturing methods. Moreover, the use of an open-space separator requires that the anode and cathode have significant structural integrity and be geometrically far enough apart to prevent electrical contact (i.e., electrode short circuiting). Furthermore, the large interelectrode spacing of these batteries imposed by the rigid support limits high rate performance.

Cells constructed with plastic-bonded, sintered, fiber, or foam electrodes are often lower in cost than cells with pocket plate electrodes. The electrode manufacturing process is cheaper, easier, and provides greater consistency between electrodes than the pocket plate design. They may also offer other advantages such as higher rate capability and greater energy density, since the interelectrode spacing is small as the electrodes are held in place through compression. They do have the disadvantage of the potential for the active material to become dislodged or lost from the electrode as a result of vibration or expansion and contraction of the electrode during cycling unlike the pocket plate design where the active material is encased by the substrate. In order to help prevent the loss of active material from the electrodes, a special woven, non-woven, felt, cloth, or microporous fabric is placed between the anode and cathode which applies pressure equally across the electrodes. These traditional separators help maintain the integrity of the electrode through compression in addition to keeping the anode and cathode electrically isolated while providing ionic contact through the electrolyte. However, in providing intimate contact between the separator and the electrode surface, the relatively small pore structure of these separators can trap gas generated at the electrode surface. Such trapped gas can interfere with ionic transport and electrochemical reactions at the electrode surface and adversely affect battery performance.

The generation of gas is usually the consequence of charging by which water is reduced to hydrogen gas and hydroxide according to Equation 1. The generation of gas is especially significant in some alkaline batteries such as Ni-Fe batteries where the electrochemical potential for the reduction of water is actually more positive (ie. more favored thermodynamically) than the reduction of Fe(OH)₂ to iron metal which recharges the anode as shown in Equation 2 below. Self-discharge of iron electrodes, Equation 3, also leads to hydrogen gas evolution.

2 H₂O+2e⁻→H₂+2 OH^{- E°=-}0.828 V 1

Fe(OH)₂+2e^{-→Fe+}2 OH^{- E°=-}0.877 V 2

Fe+H₂O→Fe(OH)₂+H₂ 3

The cathode (positive electrode) also generates oxygen (O₂) gas during overcharge by oxidizing the hydroxide ion in the electrolyte according to Equation 4:

4 OH—→O₂(g)+2 H₂O+4 e− 4

A separator which is designed to provide the channeling of gas so as to allow the gas to escape from between the electrodes even while pressure is applied to the electrodes would be of great benefit to the industry. Battery cells containing such a separator would experience improved performance characteristics.

### SUMMARY OF THE INVENTION

Provided is an alkaline battery comprising a positive electrode, a negative electrode, electrolyte, and a polyolefin separator/inlay interposed between the positive and negative electrodes, with the polyolefin separator/inlay having channels that allow movement of the gas. In one embodiment the polyolefin separator/inlay is comprised of a polyethylene, polypropylene, polybutene, polymethylpentene or a mixture thereof.

In another embodiment, there is provided a polyolefin separator/inlay for placement between a positive electrode and a negative electrode, comprising gas channels that exist in at least two planes. In one embodiment, the polyolefin separator/inlay is from 50-120 mils thick.

Among other factors, the present invention provides a polyolefin gas channeling device which electrically isolates the anode and cathode and allows gas to escape from between the electrodes while pressure is applied to hold the electrodes in contact with the device in an alkaline electrolyte. In one embodiment, the gas channels exist in at least two planes. The device, a polyolefin separator/inlay, should also have a thickness of at least 50 mils. The present invention allows electrodes with active material pasted to a single substrate through a binder to maintain their integrity without a microporous separator that can trap gases, which gases interfere with electrochemical reactions at the electrode surface.

The present invention further allows electrodes with an active material pasted to the substrate to be compressed while providing channels for gas to escape. Compression of the electrodes minimizes the interelectrode distance, thereby enhancing rate capability and energy density, while helping the electrodes to maintain their integrity.

### BRIEF DESCRIPTION OF THE DRAWINGS

FIG. 1 illustrates a top down view of the separator/inlay. The polyolefin inlay may be woven or non-woven.

FIG. 2 illustrates a cross-sectional view of a non-woven polyolefin separator/inlay interposed between an anode and cathode. The strands of this inlay are laid on top of the other strands running in the other direction.

FIG. 3 illustrates a top down view of the separator/inlay across an electrode.

### DETAILED DESCRIPTION OF THE PREFERRED EMBODIMENTS

The present invention provides an alkaline cell with a polyolefin separator/inlay that when placed between the anode and cathode in an alkaline battery provides electrical isolation of the electrodes, and also provides channels between the electrodes in which gas and electrolyte may flow while the electrode stack is compressed. The separator/inlay is generally centered between the electrodes to ensure the electrodes are isolated and do not contact each other. A preferred alkaline battery is a Ni-Fe battery.

The battery may be prepared by conventional processing and construction. The electrodes can be sintered or a coated single substrate electrode. The electrodes of the present invention are generally single layer substrates, e.g., sintered or a coated single substrate electrode.

In one embodiment, a nickel oxyhydroxide positive electrode, an alkaline electrolyte, and an iron electrode are employed. The nickel electrode may be of a sintered type well known in the art or may be of a pasted type employing a foam or felt matrix. The iron electrode may be of a sintered type well known in the art or may be of a pasted type employing a foam or comprised of a single conductive substrate coated with iron active material on one or both sides.

A preferred negative electrode is a pasted iron electrode. In the electrode, a single layer of substrate is used. This single layer acts as a carrier with coated material bonded to at least one side. In one embodiment, both sides of the substrate are coated. This substrate may be a thin conductive material such as a metal foil or sheet, metal foam, metal mesh, woven metal, or expanded metal. For example, 0.004 inch thick perforated nickel plated steel has been used.

The coating mix is a combination of binder and active materials in aqueous or organic solution. The mix can also contain other additives such as pore formers. Pore formers are often used to insure sufficient H₂ movement in the electrode. Without sufficient H₂ diffusion, the capacity of the battery will be adversely affected. The binder materials have properties that provide adhesion and bonding between the active material particles, both to themselves and to the substrate current carrier. The binder is generally resistant to degradation due to aging, temperature, and caustic environment. The binder can comprise polymers, alcohols, rubbers, and other materials, such as an advanced latex formulation that has been proven effective. A polyvinyl alcohol binder is used in one embodiment.

The active material for the mix formulation is selected from iron species that can be reversibly oxidized and reduced. Such materials include metal Fe and iron oxide materials. The iron oxide material will convert to iron metal when a charge is applied. Suitable iron oxide materials include Fe₃O₄ and Fe₂O₃. In addition, any other additives may be added to the mix formulation. These additives include but are not limited to sulfur, antimony, selenium, and tellurium.

The battery electrolyte may be comprised of a KOH solution or alternatively a NaOH based electrolyte. A preferred electrolyte comprises NaOH, LiOH, and a sulfide additive such as Na₂S.

The polyolefin separator/inlay is a mesh-like divider that prevents electrical contact between the anode and cathode but has an open structure between strands which the electrolyte fills. The inlay has channels that allow movement of gas bubbles. In one embodiment, the channels exist in at least two planes. During charge and to a lesser extent during stand, hydrogen gas may be generated from corrosion of the anode and oxygen gas may be generated at the cathode. The polyolefin separator/inlay of the present invention has channels between the strands, in which the gases may move through the electrolyte eventually reaching the surface of the electrolyte where it may escape from the cell. The inlay allows pressure to be applied to the electrode stack which minimizes distance between electrodes to keep ionic resistance low and helps maintain electrode alignment and integrity similar to cells with traditional separators. Traditional separators allow pressure to be applied to the electrode stack but gas may become trapped in the separator pores or along the surface of the electrode between the electrode and the separator since there is no clear path for the gas bubbles to diffuse. In such instances, the gas interferes with ionic transport and electrochemical reactions at the electrode surface ultimately effecting battery performance.

There is a variety of separator/inlay materials and separator inlay designs that may be used in these batteries. The separator inlay is comprised of a polyolefin material. The polyolefins can comprise a polyethylene, polypropylene, polybutene or polymethyl pentene, for example. Blends or copolymers of polyolefins can also be used. By use of the present separator/inlay one can prevent electrical contact between the anode (negative electrode) and cathode (positive electrode) while providing minimal electrolyte (ionic) resistance. The design of the separator is a grid-like mesh or woven inlay with gas channels for gas to move within the space formed by the fibers.

It is also most advantageous that the thickness of the inlay is at least 50 mils. In one embodiment, the thickness ranges from 50-120 mils. In another embodiment, the thickness ranges from 50-80 mils, and in another embodiment, from 60-70 mils.

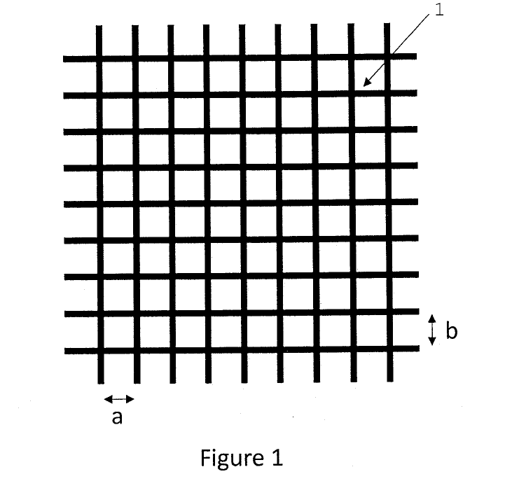

FIG. 1 shows a top down view of the structure of the inlay 1. The distance between the vertical strands and the distance between the horizontal strand defined by a and b respectively may be equal or unequal.

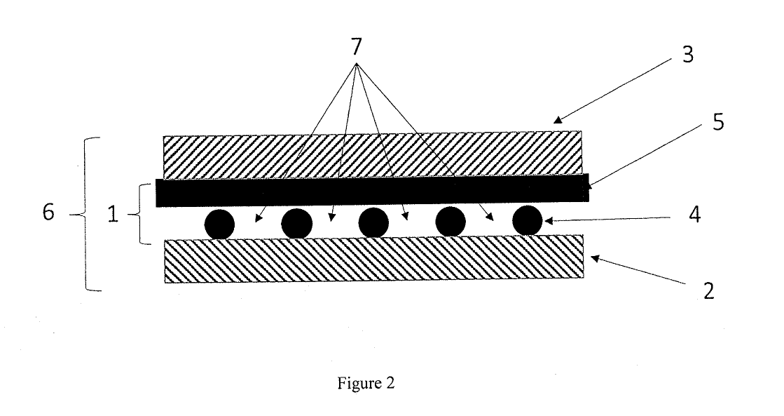

FIG. 2 shows a nonwoven inlay 1 interposed between the anode 2 and the cathode 3. The strands 4 and 5 of inlay 1 prevent electrical contact between the anode 2 and cathode 3 while providing support to the overall electrode stack 6. The gap between the strands is occupied by electrolyte in the electrochemical cell providing ionic contact between the anode and cathode. The space 7 between the individual strands parallel to each other provide a channel in which generated gas that displaces the electrolyte can migrate to the electrode edges where it will not interfere with electrochemical reactions at the electrode surfaces and ionic transfer between the electrodes. The strands 4 create channels in one plane, while the strands 5 create channels in a second plane. Having channels in two planes facilitates migration of the gas. Having multiple channels at different levels or directions, ie., in different planes, allows easier and faster migration of the gases, while also insuring that the gas can migrate. Because the migration of the gas through the channels to the electrode edges is driven by the high buoyancy of the gas, it is required that the channels be oriented so that the gas can migrate upward.

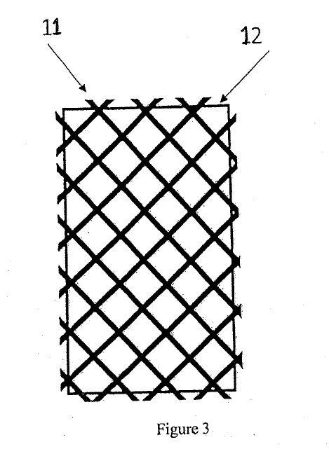

FIG. 3 shows an orientation of the inlay 11 across an electrode 12 surface in which the channels direct gas to either the top of the electrode stack or to the side. The inlay covers the entire electrode area to prevent contact of the anode and cathode.

A polyolefin woven inlay is used to provide electrical separation between the anode and cathode. The electrolyte fills the space between strands. Upon gas generation, the electrolyte is displaced by the gas. As with the non-woven inlay 1 depicted in FIG. 2, there are gaps between strands that allow gas to migrate to the electrode edges.

The polyolefin inlay that is placed between the anode and cathode is resistant to an alkaline electrolyte. In one embodiment, the separator inlay is comprised of polypropylene, polyethylene, or a polyolefin blend material. Any suitable polyolefin can be used, either as a homopolymer, in a copolymer or in a blend of polyolefins. These materials may be extruded or woven to create the inlay as long as channels or paths exist for gas to flow between the strands of the inlay.

It has been found that the dimensions of the inlay are important to the performance of nickel-iron cells. In general, the inlays have greater height and width then the anode and cathode for proper electrical isolation of the two electrodes. It has further been found that it is preferable that the inlay have a thickness between 10 and 120 mils. In a preferred embodiment, the inlay is 50 to 80 mils thick. The area between strands is preferably 50 to 45000 mil². In a preferred embodiment, the area between strands is between 500 to 10000 mil². The diameter of the strand is preferred to be between 5 to 80 mils and more preferred to be between 20 to 40 mils.

Test cells with the different inlays were subjected to an accelerated life test at 55° C. with the following testing regime:
Cycle 1 (at room temperature): Charge: 0.4 A×10 h
   Rest: 1 min
   Discharge: 0.2 A to 0.9 V
   Rest: 15 min
Cycle 2-10 (room temperature): Charge: 0.4 A×5 h
   Rest: none
   Discharge: 0.2 A to 0.9 V
   Rest: none

Electrochemical test data with inlays of various dimensions is listed in Table 1. In all tests, the inlays were sufficiently large to fully cover the surface of the electrodes. Testing was performed on 1.6 Ah cells. The iron electrode was prepared by impregnating a nickel foam substrate with a paste consisting of iron powder, nickel powder, sulfur, and polyvinyl alcohol in water followed by drying. Two commercially available sintered nickel positive electrodes were used as positive electrodes. The anode and cathode electrodes were each cut into 1.75″×3.0″ pieces with the active material covering a 1.75″×2.75″ area of the electrode. Three iron electrodes with a nickel foam current collector were used as the negative electrode. The positive electrodes were placed between the negative electrodes with two negative electrodes on the outside and one negative electrode sandwiched between the two positive electrodes. The electrode stack with a polyolefin separator/inlay placed between each negative and positive electrode was then put into the sample jar which served as the cell case. A 6 M NaOH and 1 M LiOH electrolyte solution was then added to the cell so that the cell was flooded.

TABLE 1

| | | | | | | | | | | Capacity | | | | | | | |
|---|---|---|---|---|---|---|---|---|---|---|---|---|---|---|---|---|---|
| | | | | | | | | | | (Ah) | | | | | | | |
| | Opening | Strand | | 10 cycles | | 50 cycles | | 100 cycles | | 150 cycles | | 200 cycles | | 300 cycles | | 400 cycles | |
| Material | Size | diameter | Thickness | Cell | Cell | Cell | Cell | Cell | Cell | Cell | Cell | Cell | Cell | Cell | Cell | Cell | Cell |
| Composition | (mil) | (mil) | (mil) | 1 | 2 | 1 | 2 | 1 | 2 | 1 | 2 | 1 | 2 | 1 | 2 | 1 | 2 |
| PE | 150 × 150 | 25 × 30 | 50 | 1.38 | 1.40 | 1.60 | 1.58 | 1.62 | 1.59 | 1.54 | 1.45 | 1.32 | 1.18 | 1.02 | 0.84 | 0.53 | 0.52 |
| PP | 25 × 30 | 14 | 14 | 1.26 | 1.16 | 0.39 | 0.42 | | | | | | | | | | |
| PP | 8.3 × 8.3 | 6.5 | 12 | 1.26 | 1.26 | 1.14 | 0.51 | 0.60 | | 0.11 | | | | | | | |
| PP | 80 × 100 | 55 | 47 | 1.15 | 1.05 | 0.40 | 0.46 | 0.75 | 0.87 | 0.62 | 0.60 | | | | | | |

Polypropylene and polyethylene were found to be suitable in the alkaline electrolytes. Polyolefin blends are expected to offer good performance as well. The best cycle life was obtained with inlays having a thickness of 50 mil or greater. Good cycle life was observed with materials having a mesh size up to 150×150 mil. Meshes with larger openings may need to be thicker.

While the foregoing written description of the invention enables one of ordinary skill to make and use what is considered presently to be the best mode thereof, those of ordinary skill will understand and appreciate the existence of various, combination, and equivalents of the specific embodiment, method, and examples therein. The invention should therefore not be limited by the above described embodiment, method and examples, but by all embodiments and methods within the scope and spirit of the inventions and the claims appended therein.

What is claimed is:

1. An alkaline battery comprising a positive electrode, a negative electrode, electrolyte, and a polyolefin separator/inlay interposed between the positive and negative electrodes, with the polyolefin separator/inlay having channels that allow movement of the gas.

2. The alkaline battery of claim 1, wherein the separator/inlay is comprised of polyethylene, polypropylene, polybutene or polymethylpentene.

3. The alkaline battery of claim 1, wherein the separator/inlay is a nonwoven material.

4. The alkaline battery of claim 1, wherein the separator/inlay is at least 50 mils thick.

5. The alkaline battery of claim 1, wherein the channels exist in at least two planes.

6. The alkaline battery of claim 1, wherein the electrolyte comprises sodium hydroxide, lithium hydroxide and a sulfur compound.

7. The alkaline battery of claim 6, wherein the sulfur compound is Na₂S.

8. The alkaline battery of claim 1, wherein the separator/inlay is in contact with either the positive or negative electrode.

9. The alkaline battery of claim 8, wherein pressure is applied to the electrodes.

10. The alkaline battery of claim 1, wherein the electrodes are single layer substrate electrodes.

11. The alkaline battery of claim 10, wherein the negative electrode is a coated single layer substrate electrode.

12. The alkaline battery of claim 10, wherein the electrodes are sintered.

13. The alkaline battery of claim 2, wherein the separator/inlay is a nonwoven material.

14. The alkaline battery of claim 2, wherein the separator/inlay is at least 50 mil thick.

15. The alkaline battery of claim 2, wherein the separator/inlay is from 50-120 mils thick.

16. The alkaline battery of claim 2, wherein the separator/inlay is from 50-80 mils thick.

17. The alkaline battery of claim 2, wherein the separator/inlay is from 60-70 mils thick.

18. The alkaline battery of claim 2, wherein the channels exist in at least two planes.

19. The alkaline battery of claim 14, wherein the separator/inlay is nonwoven material.

20. The alkaline battery of claim 2, wherein the separator/inlay is comprised of polyethylene.

21. The alkaline battery of claim 2, wherein the separator/inlay is comprised of polypropylene.

22. The alkaline battery of claim 2, wherein the separator/inlay is comprised of polybutene.

23. The alkaline battery of claim 2, wherein the separator/inlay is comprised of polymethylpentene.
